(19) United States
(12) Patent Application Publication
(10) Pub. No.: US 2005/0224292 A1
(43) Pub. Date: Oct. 13, 2005

(54) Bag/box unit for disposal of used engine oil

(76) Inventor: Gonzalo R. Rubang JR., Fairfield, CA (US)

Correspondence Address: Robert K. Tendler, 65 Atlantic Avenue, Boston, MA, 02110, US

(21) Appl. No.: 10/821,511

(22) Filed: Apr. 9, 2004

(51) Int. Cl. F16N 33/00

(52) U.S. Cl. 184/1.5

(57) ABSTRACT

A collapsible box with an interlocking lip-sealable plastic bag as a liner is unfolded to open the sealable bag to permit oil from a crankcase to be ecologically removed during an oil change. When all of the oil has been removed, the bag is sealed and the box with the bag is transported to a disposal site where it may be safely handled. In one embodiment, the box with the bag is provided with a capped outlet port such that the oil from the bag can be removed by uncapping the outlet port where it may be made to drain into an approved receptacle. In another embodiment the bag is adhesively secured to the walls of the box so that the bag is supported when the box is opened and upright so as to be able to receive the draining oil. In a still further embodiment the bag is folded down over the box to overlap the upper portion of the box such that opening of the box provides an expanded aperture for the bag into which drained oil may be directed. The oil bag/box combination is designed to be collapsible so that it can be folded flat and stacked for easy storage. In another embodiment the box is provided with foldable handles to facilitate carrying.

### FIELD OF THE INVENTION

This invention relates to oil disposal and more particularly to a convenient bag/box combination for receiving drained oil so that it can be safely removed and disposed of.

### BACKGROUND OF THE INVENTION

Automotive oil change apparatus is well known. However, for the so-called do-it-yourselfers, there is nonetheless a need for a convenient way to dispose of the oil during an oil change operation.

As illustrated by U.S. Pat. No. 5,074,379, disposable bags have been utilized to collect the oil drained from the crankcase of a motor, although bags in general are not terribly useful without some support apparatus to keep them upright during the draining of the oil.

Another type of oil drain bag is shown in U.S. Pat. No. 4,064,969 and is constructed so that the mouth of the bag is held open and elevated above the general level of the bag when the bag is laid on the ground beneath the engine so that as the oil runs into the mouth of the bag, it is permitted to run into the body of the bag as well. In one embodiment the mouth of the bag is maintained in the appropriate upward position by a metal frame, whereas in another embodiment the mouth of the bag is provided with a structure of relatively heavy material such as cardboard or the like, with the cardboard surrounding at least three sides. In this patent the bag is attached to the outside of the frame and extends laterally on the ground outside of the cardboard.

U.S. Pat. No. 4,020,922 describes a filter catcher which is a tool for use by an automobile mechanic when changing an oil filter and which prevents the mechanic from becoming burned by hot oil running out of the engine block. The tool consists of an adapter to which a disposable plastic bag is attachable, with the adapter being fitted around a lower portion of the engine block on the downwardly depending oil filter which extends into the bag. Here the bag is not self-supporting.

U.S. Pat. No. 4,485,853 describes another oil changing method in which an oil change device has a concave collection receptacle formed from a thin circular plastic sheet which is attached to and supported by a heavier plastic strip bent into a cylinder. A slot in the cylinder provides a handhold to permit readily holding the device in one hand. This device is held in one hand and is placed near a drain plug of an oil pan and the drain plug is then loosened through the plastic sheet using the other hand. The plastic sheet captures and contains the drain plug and also protects the hands, arms and clothing from the drain oil. After the drain plug is removed, the device is moved to permit the oil to drain into a conventional oil pan. Thus, no bag for containing the crankcase oil is described.

The problems with the above-mentioned oil drain methods are that there is no convenient foldable device which may be used to capture the oil and to seal the container with a simple yet effective fluid-locking seal. The ability to provide such a device is required to meet the environmental standards for the disposal of the crankcase oil so that the disposed crankcase oil may be transported from the vicinity of the engine block to a place where the oil may be disposed of in an ecological fashion.

### SUMMARY OF INVENTION

In the subject invention, a bag with an interlocking sealable mouth is disposed within a foldable box with the upper portions of the bag secured to the inner sides of the box when the box is opened from its folded condition. Such a bag in one embodiment is called a Ziplock® bag in which the interlocking members are joined together with a zipper mechanism. While not limited thereto, the subject bag will be referred to as a Ziplock® bag, although other interlocking mouth bags without zipper mechanisms are within the scope of this invention. In one embodiment, the mouth of the bag is opened by means of the Ziplock® zipper being moved to the open position, which then provides a mouth into which oil dripping from the oil pan may be directed during an oil change. The box itself is self-supporting and the bag is fixed to and contained completely within the box. Thus, the box with the internally carried bag opened at the top may be positioned underneath the oil pan and oil drain plug and the drained oil can flow into the bag without having to support the bag otherwise.

Upon the complete removal of the oil during the oil change operation the Ziplock® bag is sealed shut by movement of the zipper to the closed position, thus to seal the oil within the bag within the box. The box in one embodiment is provided with a cover which comes down over the mouth of the bag and the entire box and bag may be removed to a disposal site without leakage of the drained oil.

In one embodiment, the bag/box combination is provided with an outlet spout which is capped. The disposed oil in the bag may be emptied by virtue of removing the cap from the spout, which is at the bottom of the bag/box combination so that the oil may be transported from the oil drain position underneath the chassis of the car to a convenient oil disposal drum or receptacle, thereby eliminating the need to dispose of the filled bag/box combination at a disposal site. The oil thus collected may be removed through this capped spot at the bottom of the bag/box combination into a disposal drum at a gas station or the like without having to transport the bag/box combination to a distant disposal-site.

The result is that one can conveniently change the oil in an engine crankcase with a bag/box combination which initially is folded flat so as to be stackable in a display rack, and which can be expanded and positioned beneath an oil pan drain plug in a self-supporting manner so that oil may be collected through an open mouth provided by opening the interlocking mouth of the bag after the bag/box combination is opened and positioned in place.

In summary, collapsible box with an interlocking lip-sealable plastic bag as a liner is unfolded to open the sealable bag to permit oil from a crankcase to be ecologically removed during an oil change. When all of the oil has been removed, the bag is sealed and the box with the bag is transported to a disposal site where it may be safely handled. In one embodiment, the box with the bag is provided with a capped outlet port such that the oil from the bag can be removed by uncapping the outlet port where it may be made to drain into an approved receptacle. In another embodiment the bag is adhesively secured to the walls of the box so that the bag is supported when the box is opened and upright so as to be able to receive the draining oil. In a still further embodiment the bag is folded down over the box to overlap the upper portion of the box such that opening of the box provides an expanded aperture for the bag into which drained oil may be directed. The oil bag/box combination is designed to be collapsible so that it can be folded flat and stacked for easy storage. In another embodiment the box is provided with foldable handles to facilitate carrying.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of the oil change operation for the removal of oil from the crankcase of an engine, showing the positioning of a sealable bag/box combination underneath the oil pan, with the oil draining into the mouth of the sealable bag which has been opened;

FIG. 2 is a diagrammatic illustration of one embodiment of the bag/box combination illustrating a Ziplock® bag housed within a box, with the box in an open position;

FIG. 3 is a diagrammatic illustration of the bag/box combination of FIG. 2, with the box collapsed flat along with the bag therein;

FIG. 4 is a diagrammatic illustration of a filled bag interior to a collapsible box having a collapsible cover which can be folded down over the sealed bag when the bag has been filled, also illustrating a capped outlet port;

FIG. 5 is a diagrammatic illustration of the bag/box combination of FIG. 4, illustrating the folding flap structure of the FIG. 4 bag/box combination used in the storage and display of the device;

FIG. 6 is a diagrammatic illustration of one embodiment of the bag/box combination of FIG. 4, illustrating the opening of a Ziplock® bag when the box has been expanded to its appropriate shape, showing the mouth of the bag being opened by moving the zipper to the right-hand-most position;

FIG. 7 is a diagrammatic illustration of the bag/box combination of FIG. 4, illustrating the folding down of the top of the box after the bag has been filled, showing the folding of the top leaves of the box downwardly;

FIG. 8 is a diagrammatic illustration of the box of FIG. 7 with the top having been folded down over the internally-carried bag, such that the oil may be transported by using a closed box;

FIG. 9 is a side view of the box of FIG. 1, illustrating the bag adhesively attached to the sides of the box, with the mouth of the bag extending up above the top lip of the box and with various folding tabs shown in dotted outline which, when engaged, forming the bottom of the box;

FIG. 10 is a top view of the box of FIG. 9, illustrating the opening of the mouth of the bag and the folding down of the tabs to form the bottom of the box;

FIGS. 11A-C are diagrammatic illustrations of the top closure of a box containing the internally-carried bag, showing inward folding of top sections of the box to points insertable into corresponding slits in the box to lock the sections in place for secure top closure; and,

FIG. 12 is a diagrammatic illustration of an embodiment wherein the top portion of the internally-carried bag extends over the top lip of the box and down over the corresponding upper sides of the box so as to open the mouth of the bag when the box is opened for receipt of draining oil.

### DETAILED DESCRIPTION

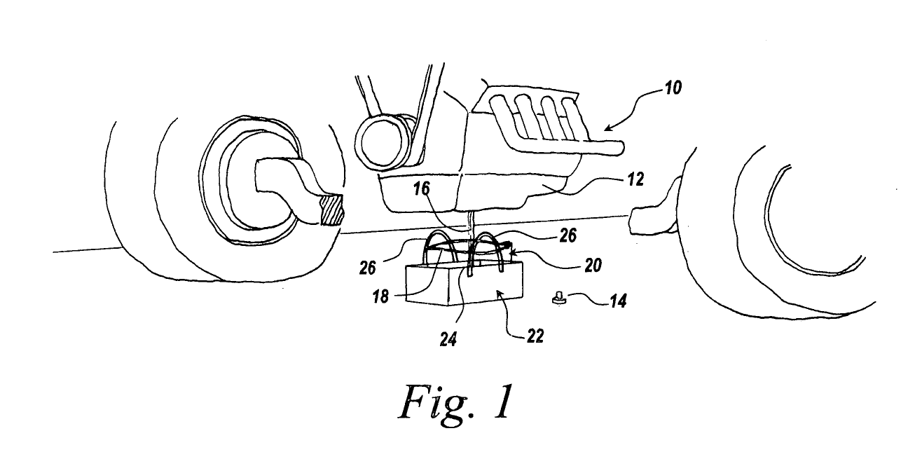

Referring now to FIG. 1, in an oil change operation, a motor 10 is shown having an oil pan 12 which has an oil plug 14 removed from the bottom of the pan. The result of having removed the plug is the discharge of oil 15 in a vertical flow into the mouth 18, of a sealable bag 20 disposed within a rigid-walled box 22 which houses the sealable bag with mouth 18 projecting above the lip of 24 of box 22. The opening of box 22 permits opening the mouth 18 of bag 20 so as to be able to receive the flow of oil 16 from the crankcase. In one embodiment, box 22 is provided with foldable handles 26 for case of transport.

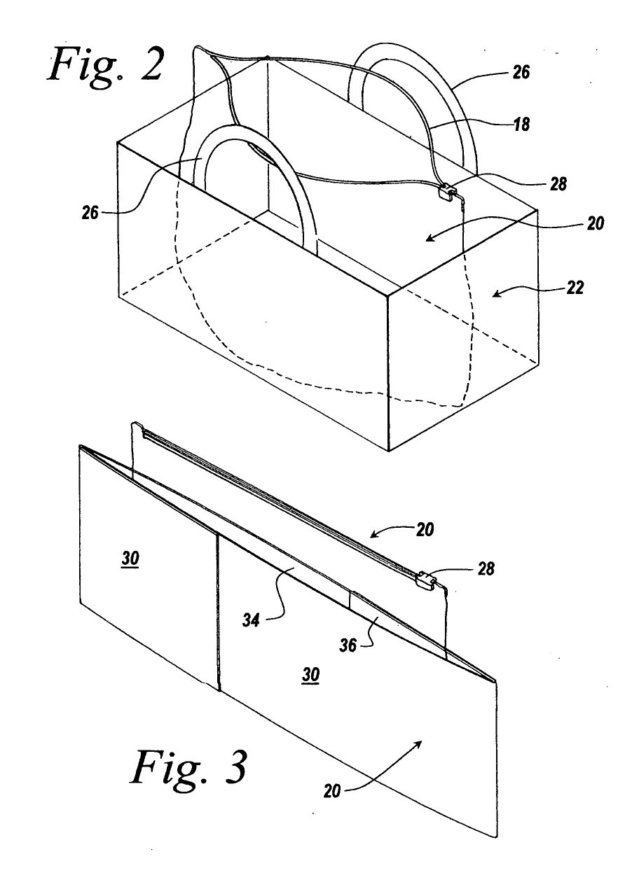

Referring to FIG. 2, what will be seen is a diagrammatic illustration of one embodiment of the invention showing box 22 housing a Ziplock® bag 20 therein, with the mouth 18 of bag 20 opened by virtue of sliding a zipper 28 to the right as illustrated. Note that box 20 may be provided with handles 22 to facilitate handling.

Referring to FIG. 3, box and bag 20 and 22 respectively may be collapsed for storage purposes, with walls 30, 32, 34 and 36 of box 22 being shown in the flattened position, along with the flattened position of bag 20.

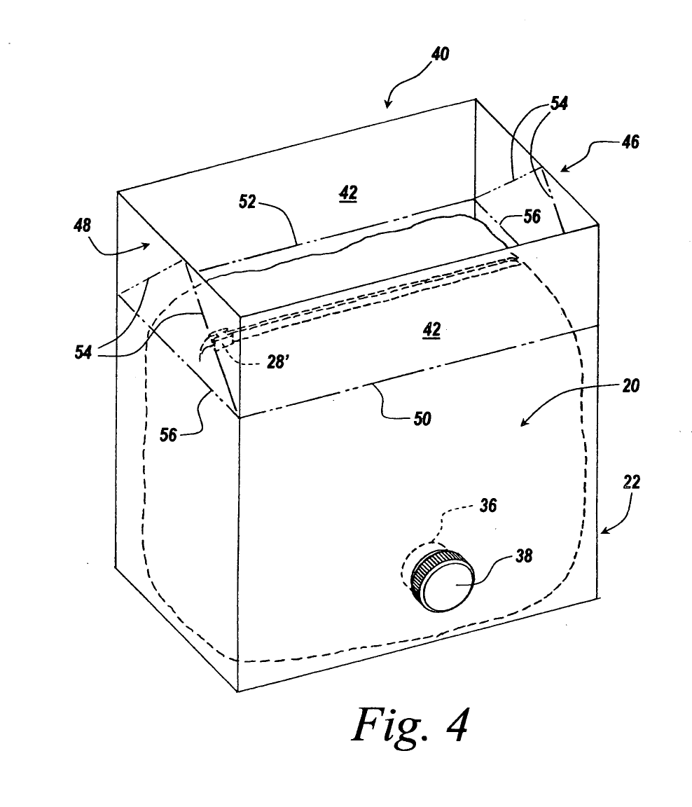

Referring to FIG. 4, in one embodiment the bag/box combination is illustrated in which a filled bag 20 is illustrated in which the bag has been sealed shut by movement of zipper 28 to the position 28′.

Here it can be seen that an outlet port 36 is provided with a cap 38 for ease of removal of the contents of bag 20 when the bag/box combination has been filled with disposed oil.

In the embodiment of FIG. 4, box 22 has a collapsible top portion 40 which is comprised of opposed sides 42 and 44, and by collapsible side portions 46 and 48. The top 40 is collapsed down on the top of bag 20 by folding side portions 42 and 44 inwardly along fold lines 50 and 52 while at the same time folding sides 46 and 48 along fold lines 54 and 56.

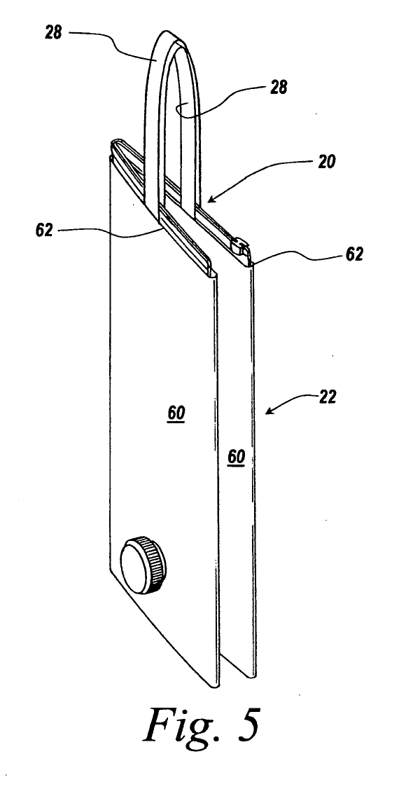

Referring to FIG. 5, for storage the bag/box of FIG. 4 is folded flat with sides 60 of box 22 folded as illustrated, and with bag 20 extending above lip 62 of folded box 22 as illustrated.

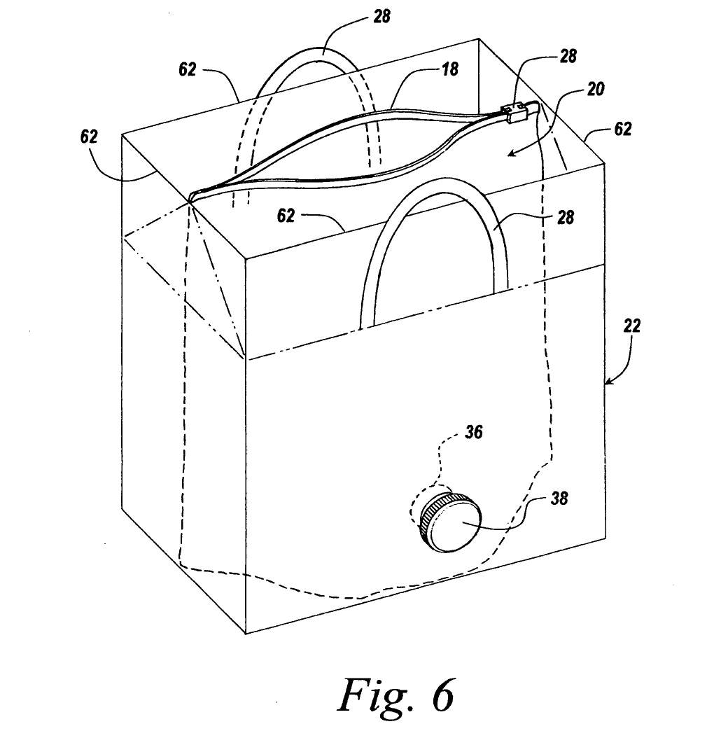

Referring to FIG. 6, when the bag/box combination of FIG. 5 is opened, sealable bag 20 has its mouth 18 opened by zipper 28.

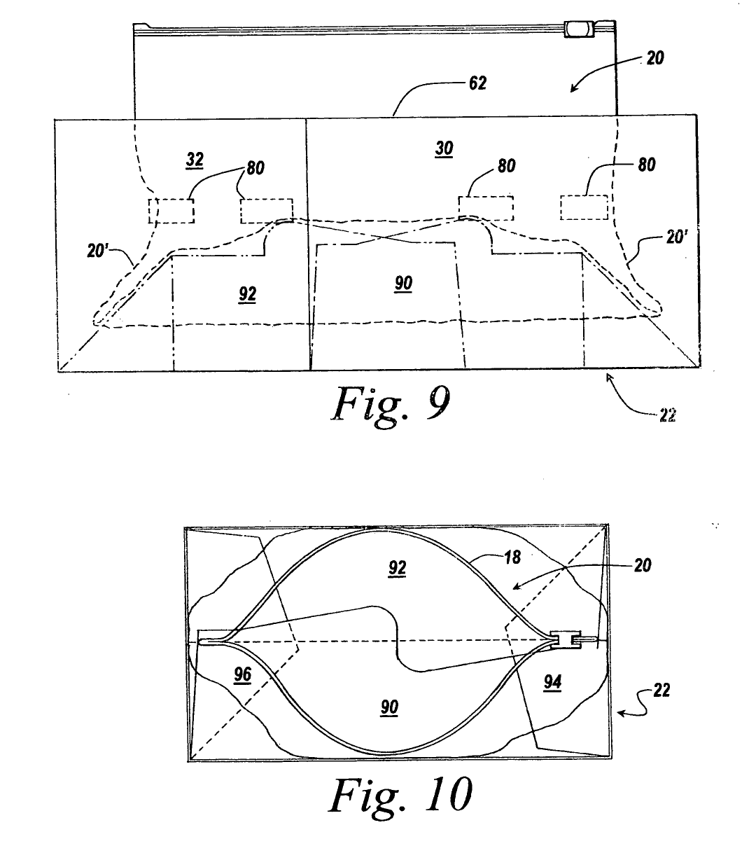

It will be appreciated that the Ziplock® bag can be secured to the upper portion of box 22 such as, for instance, by the adhesive tabs shown in FIG. 9.

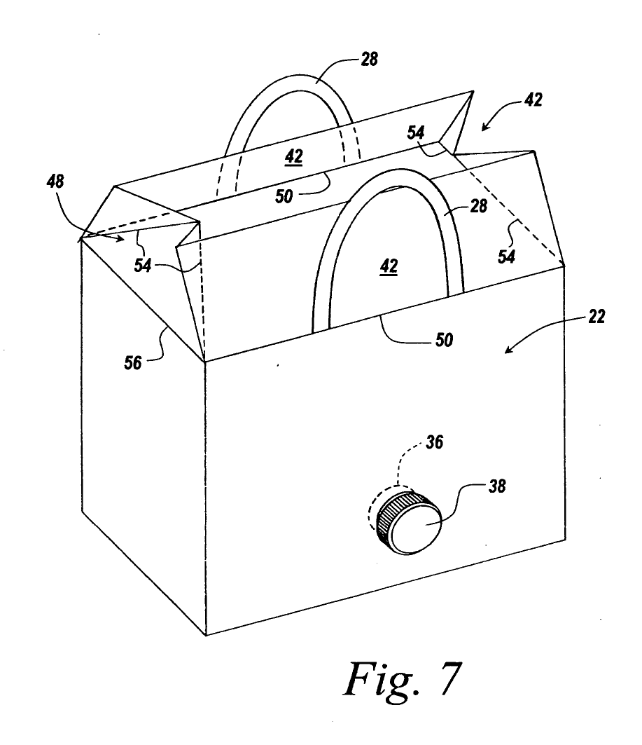

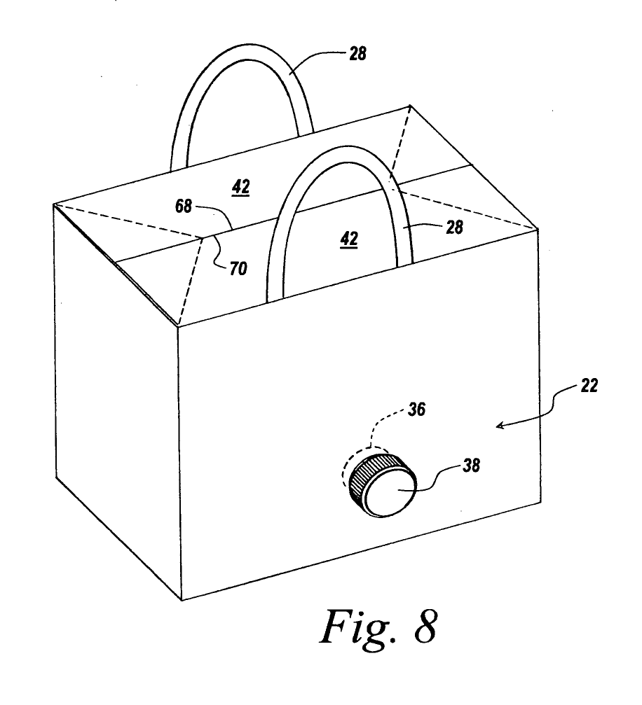

Referring to FIG. 7, once the Ziplock® bag has been filled, box 22 may be closed by moving sides 42 and 44 inwardly as illustrated, which causes sides 46 and 48 to fold along fold lines 54 and 56.

As illustrated in FIG. 8, top sides 42 and 44 are closed down over the box along mating edges 69 and 70, thus to provide a convenient box for transporting the used oil. Here handles 28 provide for convenient cartage.

Referring now to FIG. 9, in one embodiment bag 20 is contained within box 22 and extends upwardly as illustrated above lip 62. Here double-back adhesive strips 80 are used to secure the top portion of bag 20 within box 22, with the bag extending into box 22 as illustrated by the dotted lines 20′.

The bottom of the box is formed by interlocking tabs 90 and 92 which, when folded down are interlocked as illustrated in FIG. 10. Note mouth 18 of bag 20 is in the open position to receive oil. Here downwardly depending sides 94 and 96 complete the bottom portion of box 22.

What will be seen is that a convenient bag/box oil disposal unit is provided which may be conveniently placed beneath the oil pan of an engine to collect the used oil during an oil change operation. The bag/box combination can be stored flat so that it may be conveniently displayed in a rack or stacked prior to being sold. Moreover, the bag/box combination can be provided with a capped outlet orifice or spout for easy removal of oil contained within the bag should it not be desired to transport the bag/box combination itself in a sealed condition to a disposal site. Moreover and optionally, the box may be provided with foldable handles for ease of transporting of the filled bag.

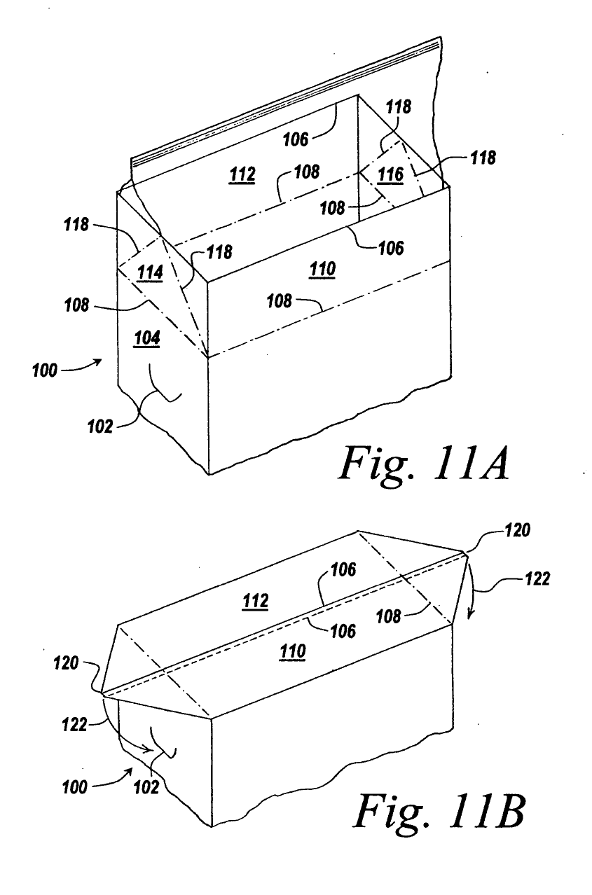

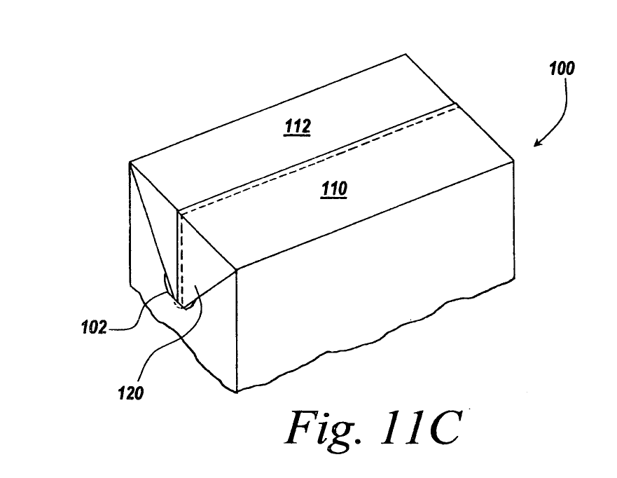

Referring now to FIG. 11A, in one embodiment a box 100 is provided with a slit 102 in a side 104 of box 100. Box 100 is provided with an upper lip 106 which may be folded down as illustrated along dotted lines 108 such that when panels 110 and 112 move inwardly, sides 114 and 116 move outwardly so as to fold along dotted lines 118.

The result as shown in FIG. 1B is that panels 110 and 112 have lips 106 which meet so as to form points 120, which are insertable into corresponding slots 102 as indicated by arrows 122.

Referring to FIG. 11C, what is shown is that when points 120 are secured within slots 102 of box 100, panels 110 and 112 are secured in place over box 100 such that the top of box 100 is locked shut.

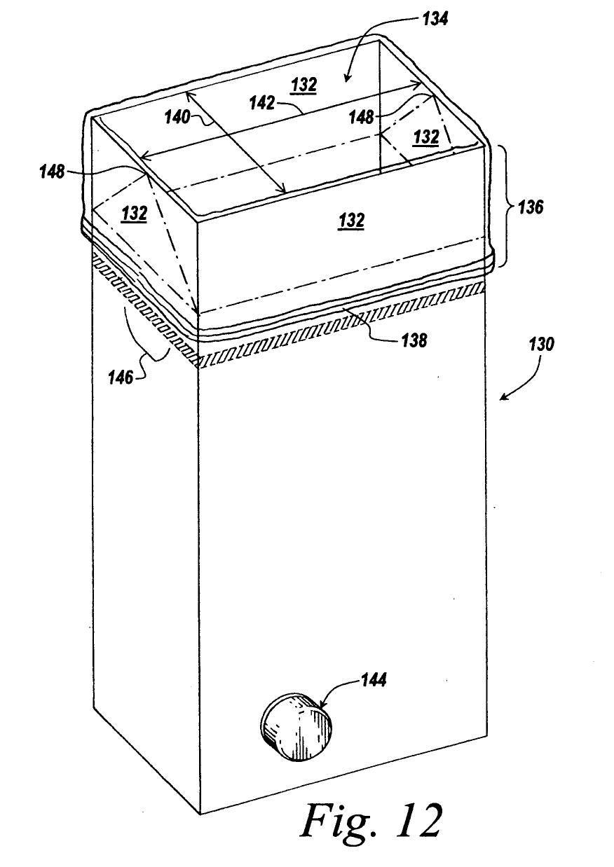

Referring now to FIG. 12, in one embodiment a box 130 is shown in which top panels 132 of the box are overlain with the internally-carried bag 134 at overlap portions 136 such that the lip 138 of bag 134 extends down and over the top portion of box 130.

The purpose of folding the bag down over the top of the box is such that an aperture shown by arrows 140 and 142 is created so that the bag has a mouth which is opened conveniently for the receipt of oil directed into the mouth during the oil change process.

Upon draining of the oil into bag 134, the lip 138 of the bag is pulled up from the top of the box 130, is sealed and then is folded into the interior of box 130, at which point panels 132 are folded in, in the same manner as illustrated in FIGS. 11A-C so as to lock the bag within box 130 for carriage to a safe disposal location. Note that box 130 is provided with a capped outlet port 144 as illustrated. Note also that box 130 is provided with slits 146 adapted to receive points 148 when the upper panels of the box are folded in the manner described in connection with FIGS. 11A-C.

Note that while the subject invention has been described in terms of a bag internally carried by a box, the box itself may be a stiff paper bag with a resilient bag therein supported by the more rigid sides of the paper bag.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. Apparatus for collection and storage of used motor oil, comprising:
a box; and,
a bag having a sealable mouth disposed in said box with said mouth exposed at the top portion of said box, said bag and box forming a unit adapted to be positioned to receive a flow of oil from an engine during an oil change operation.

2. The apparatus of claim 1, wherein said sealable mouth includes interlocking lips.

3. The apparatus of claim 2, wherein said interlocking lips run across the top portion of said bag and further include a zipper positioned to close said mouth by forcing the interlocking of said lips upon movement of said zipper in a predetermined direction.

4. The apparatus of claim 1, wherein said box has interior walls and wherein at least a portion of said bag is attached to the interior walls of said box to keep said bag from falling into said box.

5. The apparatus of claim 4, wherein said bag is secured to said box such that the upper portions of said bag are secured to the interior walls of said box.

6. The apparatus of claim 1, and further including an outlet spout having an end communicating with the interior of said bag and an opposite end extending exteriorly of said box.

7. The apparatus of claim 6, and further including a cap on said spout.

8. The apparatus of claim 1, and further including at least one handle attached to said box.

9. The apparatus of claim 8, wherein said box has opposing sides and wherein each of said opposing sides has a handle attached thereto.

10. The apparatus of claim 8, wherein said box is foldable to a flat configuration, with said bag at least partially inside of said folded box, and wherein said handle is folded flat with the folding of said box.

11. The apparatus of claim 1, wherein said box is foldable to a flat configuration, with said bag at least partially inside of said folded box.

12. The apparatus of claim 1, wherein the mouth of said bag extends above the top portion of said box.

13. The apparatus of claim 12, wherein the mouth of said bag is folded down over the top portion of said box.

14. The apparatus of claim 1, wherein said box is in the form of a foldable bag.

15. A method of ecologically disposing of oil from an engine, having a removable drain plug in a drain hole, comprising the steps of:
locating an upstanding box having a sealable bag therein, with the mouth of the bag open in position to receive a stream of oil from the unplugged drain;
filling the bag with engine oil from the drain;
sealing the mouth of the bag; and,
disposing of the box and bag.

16. The method of claim 15, and further including placing a capped drain spout in the bag and box and emptying the bag by uncapping the spout.
